(19) United States
(12) Patent Application Publication
(10) Pub. No.: US 2003/0179996 A1
(43) Pub. Date: Sep. 25, 2003

(54) Fiber optic apparatus with fiber fused lenses

(76) Inventor: Robert Fan, Canoga Park, CA (US)

Correspondence Address: COUDERT BROTHERS LLP, Third Floor, 600 Beach Street, San Francisco, CA, 94109, US

(21) Appl. No.: 10/105,999

(22) Filed: Mar. 20, 2002

(51) Int. Cl. G02B 6/32

(52) U.S. Cl. 385/34

(57) ABSTRACT

A fiber optic apparatus interfaces a single mode fiber into free space for coupling to active or passive devices with a collimated or parallel ray beam. This is accomplished by splicing or fusing to the end of the single mode fiber one of two types of lenses. The first type uses a graded index fiber which is cut to an odd multiple of a quarter wavelength of the light beam. The second technique is to use a step index fiber with a curved end forming a lens having a length relative to a hypotenuse line along the angle of emission of a single mode fiber to subtend half of the diameter of the core of the step index fiber. This, depending on the curvature at the end of the step index fiber, will produce either a collimated beam or a beam focused to a point.

### INTRODUCTION

The present invention is directed to fiber optic apparatus and more particularly to a fiber optic lens system using fiber fused lenses.

### BACKGROUND OF THE INVENTION

As illustrated in FIGS. 1A, 1B and 1C, a variety of collimating and focusing lenses are used with an optical fiber 10. As show in FIG. 1C, the diameter of such fiber is typically of 125 microns (μm). FIG. 1A illustrates a ball type lens 11. FIG. 1B is a plano-convex lens 12 or any other type of lens system. FIG. 1C is a gradient index (GRIN) lens 13. As is apparent from the drawing, all of these lenses are rather bulky and have a large cross-section. For example, see FIG. 1C where nominal dimensions of 6 millimeters and 2 millimeters are illustrated for a GRIN lens. Thus, it is difficult to use these oversize lenses especially with a bundle of very small diameter optical fibers. The lenses are necessary for both active and passive switching systems where either a collimated or focused beam must be transmitted into a free space. For example, as illustrated in FIG. 2, between the fibers 16 and 17, a collimated beam 18 in free space is attenuated by the variable optical attenuator (VOA) 19. Other devices may be tiltable mirrors in N×N crossbar switching device.

### OBJECT AND SUMMARY OF INVENTION

It is therefore the general object of the present invention to provide an improved fiber optic apparatus.

In accordance with the above objects, there is provided a fiber optic apparatus for interfacing a single mode fiber of a predetermined diameter into free space for coupling the associated light beam to active or passive devices comprising lens means of substantially the same diameter as the single mode fiber spliced to an end of such fiber for producing a collimated light beam from the single mode fiber light beam into the free space consisting of one of the following:

1) a graded index fiber cut to an odd multiple of a quarter wavelength of the light beam, or

2) a step index fiber with a curved end forming a lens which has a length relative to a hypotenuse line along the angle of emission of the single mode fiber through said step index fiber which subtends half of the diameter of the core of the step index fiber.

In addition, corresponding methods are provided.

### BRIEF DESCRIPTION OF DRAWINGS

FIGS. 1A, 1B and 1C are side views of prior art lens systems.

FIG. 2 is a side elevational view showing an active device in a fiber optical lens system.

FIG. 3 is a table illustrating three primary types of transmission modes using optical fiber.

FIG. 4 is a side elevational view of an optical fiber with a lens showing one embodiment of the present invention.

FIG. 5 is a side elevational view illustrating a step in the process of obtaining the configuration of FIG. 4.

FIG. 6 is a flow chart of the process for constructing the apparatus of FIG. 4.

FIG. 7 is a side elevational view of another embodiment of the invention.

FIG. 8 is a side elevational view of another embodiment of the invention.

FIG. 9 is a diagram illustrating the construction of FIGS. 7 and 8.

FIG. 10 is a flow chart showing the process for the construction of FIGS. 7 and 8.

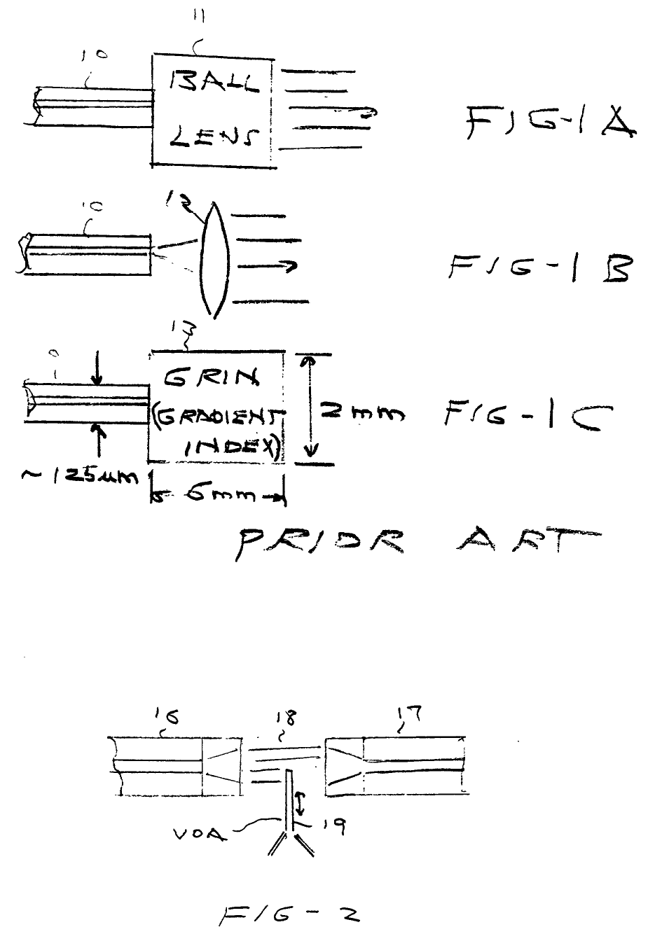

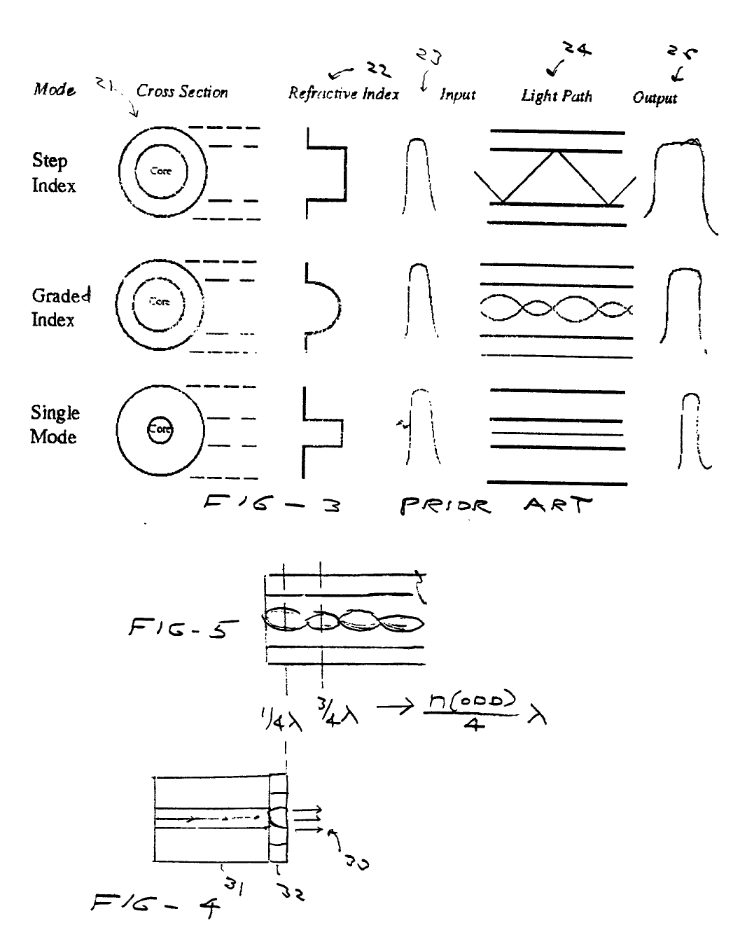

### DETAILED DESCRIPTION OF PREFERRED EMBODIMENTS

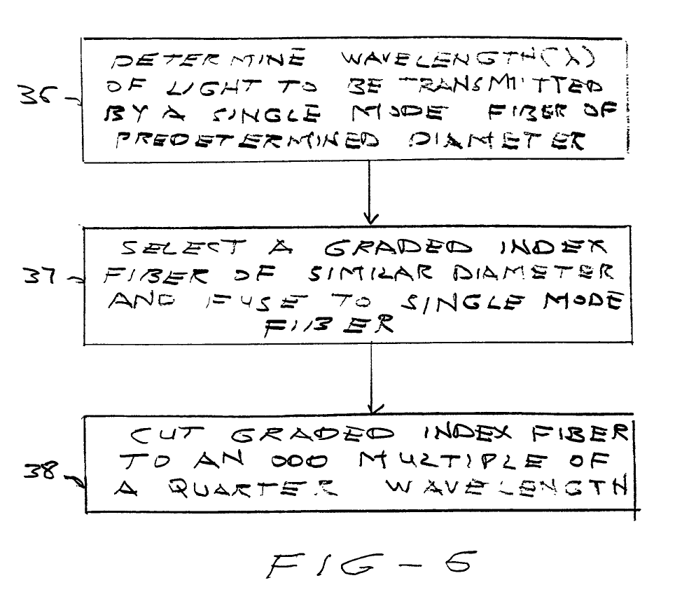

FIG. 3 illustrates three kinds of primary transmission modes using optical fiber. The cross section of the optical fibers with its core and cladding is indicated by the column 21 with the first fiber a step index type, the second a graded index type and the third single mode. All of these are used in the present invention. Column 22 is the refractive index of the fiber. Column 23 is the nominal input signal. Column 24 is the nominal light path through that particular fiber, column 26 is the output. The step index fiber has a large core relative to its exterior cladding so that the light rays as shown in column 24 tend to bounce around inside the core. The refractive index indicated in column 22 is a step function since the core has a relatively high refractive index and the outer cladding a lower refractive index.

The graded index fiber has a gradual change in the core's refractive index as indicated by the parabolic type of curve in column 22 which causes the light rays to be gradually bent back into the core path. In fact, as shown in column 24, the light path is of a cyclical type with sine waves which is predictable. This characteristic is used in the present invention.

Finally, the single mode fiber optic has a very small core with a step function between the cladding and the core. Here the light ray passes through the core with relatively few reflections off the cladding. This is to be compared to the graded index optical fiber which as illustrated has a variable refractive index that is a function of the radial distance (substantially parabolic) from the fiber axis. Thus, the refractive index gets progressively lower away from the axis. This characteristic causes the light rays to be continually refocused by refraction into the core. As a result, there is a designed continuous change in refractive index between the core and cladding along a fiber diameter which produces the characteristic shown in column 24 and also in FIG. 5 which is a replication of the same drawing.

Now referring to one embodiment of the invention and specifically FIGS. 4 and 5, here as illustrated in FIG. 4, a single mode fiber 31 is fused or spliced to a graded index fiber portion 32 to produce the collimated beam at 33. This graded index fiber 32 is cut to an odd multiple of a quarter wavelength of the light beam being transmitted by the single mode fiber 31. Thus, as illustrated in FIG. 5, a typical cut would occur at one-quarter wavelength. This occurs, as illustrated in FIG. 5, where the multiple light rays are at a maximum; this renders the light rays parallel or collimated. Similarly, as illustrated in FIG. 5, subsequent odd multiple of quarter wavelengths will provide the same function. The splicing or fusing of the lens 32 to the single mode fiber 31 may be accomplished by any standard method such as use of a torch or arc type fusion. The graded index fiber is illustrated as the same diameter as the single mode fiber and thus a fiber bundle may be easily constructed; similarly, use of such fibers, for example, in an N×N crossbar switch is facilitated.

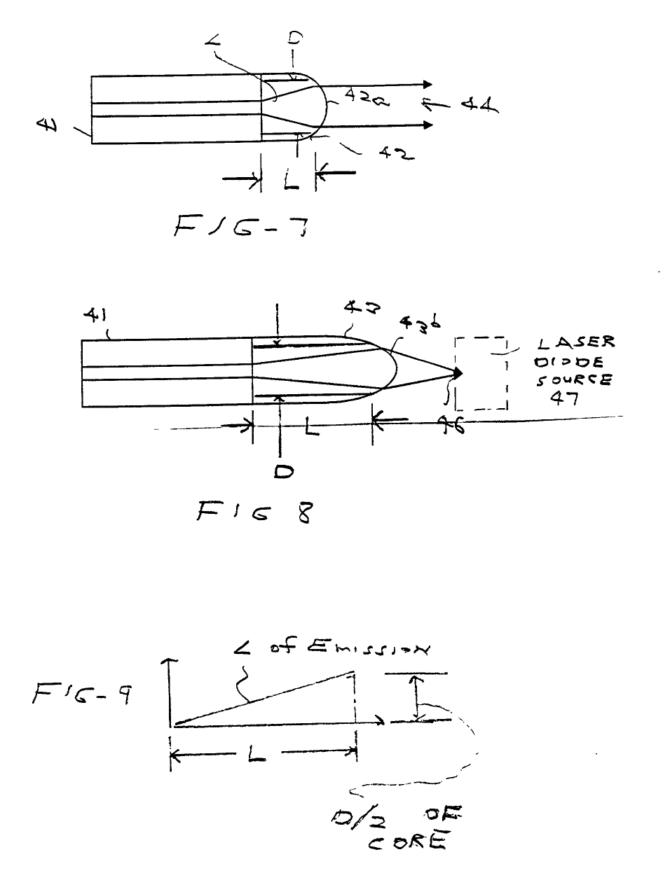

FIG. 6 illustrates the specific steps in constructing the fiber optic apparatus in FIG. 4. Here in step 36 the wavelength of the light beam being transmitted is determined and in step 37 a graded index fiber of a similar diameter is selected and fused to the single mode fiber. Finally, in step 38 the graded index fiber is cut to an odd multiple of a quarter wavelength. Thus, in summary, splicing the single mode fiber into a one-quarter pitch graded index fiber renders the diverging light rays of the single mode parallel or collimated. Theoretically the fusing may occur after cutting; however, the handling of the graded index fiber is facilitated by first fusing

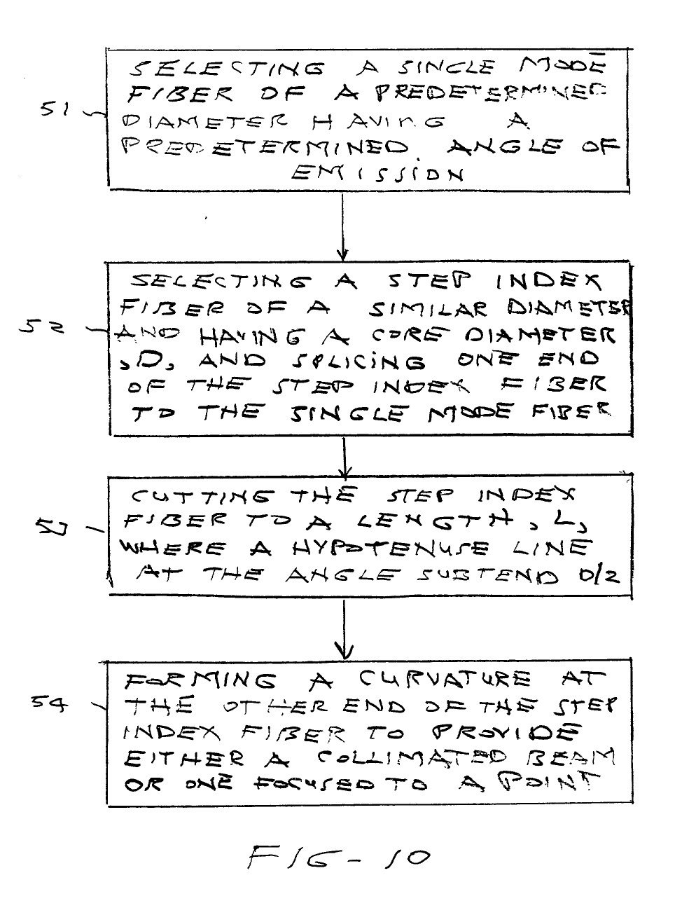

Other embodiments of the invention are illustrated in FIG. 7 and 8, where the single mode fiber 41 is spliced or fused to a step index fiber 42 or 43. At the end, 42a and 43b, of each step index fiber a curvature is formed resulting in a plano-convex lens to either columnate the light beam 44 as shown in FIG. 7 or provide a point focus 46 as in FIG. 8. In both the embodiments of FIGS. 7 and 8, this step index fiber has substantially the same diameter as the single mode fiber 41 to again provide the advantages enumerated above.

The length L of the step index fiber 42 or 43 is determined as illustrated in FIG. 9 where the angle of emission or amount of divergence of the single mode fiber 41 is known. This forms a hypotenuse which subtends half of a core diameter of the step index fiber indicated as D in FIGS. 7 through 9. Then the curvature is selected so that in 42a a collimated beam 44 is formed or a greater curvature in 43b provides a focused point 46. This is useful if, for example, a laser diode source 47 is used or in fact a laser diode receptor.

To provide the fused lens of FIGS. 7 and 8, FIG. 10 illustrates in detail the steps. In step 51 a single mode fiber is selected having a predetermined diameter and a predetermined angle of emission or divergence. In step 52, a step index fiber is selected of a similar diameter and with a core diameter, D and one end is spliced or fused to the single mode fiber. It is then in step 53 cut to a length L where the hypotenuse line following the angle of emission subtends half the core diameter of the step index fiber, D/2. In step 54, a curvature is formed at one of the step index fiber to provide either a collimated beam or one focused to a point as discussed above. Again the cutting occurs after fusing for convenience.

Thus, in summary, an improved fiber optic apparatus and specifically a fused lens fiber apparatus has been provided.

What is claimed is:

1. A fiber optic apparatus for interfacing a single mode fiber of a predetermined diameter into free space for coupling the associated light beam to active or passive devices comprising lens means of substantially the same diameter as the single mode fiber spliced to an end of such fiber for producing a collimated light beam from the single mode fiber light beam into the free space consisting of one of the following:
a) a graded index fiber cut to an odd multiple of a quarter wavelength of the light beam, or
b) a step index fiber with a curved end forming a lens which has a length relative to a hypotenuse line along the angle of emission of the single mode fiber through said step index fiber which subtends half of the diameter of the core of the step index fiber.

2. Fiber optic apparatus as in claim 1 where said splicing is by fusion.

3. Fiber optic apparatus as in claim 1 where said curved end of said step index fiber is of the spherical plano-convex type for providing a said collimated beam or a beam focused on a point.

4. A method of making a fiber optic apparatus for interfacing a single mode fiber of a predetermined diameter into free space for coupling the associated and collimated light beam to active or passive devices comprising the following steps:
a) determining the wavelength of light to be transmitted by said single mode fiber,
b) selecting a graded index fiber of similar diameter and cutting to an odd multiple of a quarter wavelength
c) splicing the graded index fiber to said single mode fiber either before or after said cutting.

5. A method of making a fiber optic apparatus for interfacing the collimated light beam of a single mode fiber into free space for coupling to active or passive devices comprising the following steps:
a) selecting a said single mode fiber of a predetermined diameter having a predetermined angle of emission;
b) selecting a step index fiber of similar diameter and having a core diameter, D; and splicing one end of the step index fiber to the single mode fiber;
c) cutting said step index fiber to a length, L, either before or after said splicing where a hypotenuse line at the angle of emission subtends D/2; and
d) forming a curvature at the other end of the step index fiber to provide either said collimated light beam or one focused to a point.
